(19) United States
(12) Patent Application Publication
(10) Pub. No.: US 2018/0241098 A1
(43) Pub. Date: Aug. 23, 2018

(54) APPARATUS AND METHOD FOR COOLING AND CHARGING OVERHEATED BATTERY

(71) Applicants: Hyun Chan KANG, Seoul (KR); ALPHATRONICS CO., LTD., Seoul (KR)

(72) Inventor: Hyun Chan KANG, Seoul (KR)

(73) Assignees: ALPHATRONICS CO., LTD., Seoul (KR); Hyun Chan KANG, Seoul (KR)

(21) Appl. No.: 15/752,589

(22) PCT Filed: Mar. 29, 2016
(86) PCT No.: PCT/KR2016/003199

§ 371 Date: Feb. 14, 2018

(30) Foreign Application Priority Data
Sep. 10, 2015 (KR) 10-2015-0128625

(51) Int. Cl. H01M 10/44; H02J 7/00

(52) U.S. Cl. CPC H01M 10/443; H01M 10/441; H02J 7/0029; H02J 7/0091; H02J 7/0093

(57) ABSTRACT

An apparatus for cooling and charging an overheated battery includes: a temperature measurement portion configured to measure a battery temperature; a voltage measurement portion configured to measure a battery voltage; a charging mode setting portion configured to set a charging mode to one mode among a constant current charging mode, a constant voltage charging mode, and a cooling charging mode on the basis of the battery temperature measured at the temperature measurement portion and the battery voltage measured at the voltage measurement portion; and a battery charging portion configured to charge a battery on the basis of a charging signal including a non-charging section and a charging section, and the charging mode set by the charging mode setting portion, wherein the charging mode setting portion sets the charging mode to a cooling charging mode when the battery temperature is greater than or equal to a preset temperature.

### TECHNICAL FIELD

The present invention relates to an apparatus and a method for cooling and charging an overheated battery, and more particularly, to an apparatus and a method for cooling and charging an overheated battery, which are capable of rapidly charging a battery which is overheated to a preset temperature or higher.

### BACKGROUND ART

FIG. 1 is a graph illustrating variations of a charging voltage and a charging current for describing a conventional battery charging method. In FIG. 1, a horizontal axis denotes a time, a vertical axis denotes strength of a current or a voltage, a graph of a dashed dotted line denotes a current graph, and a graph of a solid line denotes a voltage graph.

A lithium-based battery is typically charged by a constant current constant voltage (CCCV) method. That is, as shown in FIG. 1, charging of the battery is performed with a constant current I1 (a section T1). At this point, a voltage V1 of the battery continues to rise. After the section T1, the charging is performed with a constant voltage V2 (a section T2). Then, the charging is terminated when a charging current I2 reaches a lowest value.

At this point, in the conventional CCCV charging method, when the voltage of the battery reaches an upper limit voltage of about 4.2 V, a CV condition is maintained until a current of the battery reaches a preset low current value. In this case, there is a problem in that a charging time increases due to the CV condition such that an overall charging time of the battery increases.

Further, in the conventional CCCV charging method, when a high current charging state is maintained or a voltage charging state is maintained in a state in which the battery is overheated to a preset temperature or higher, there is a problem in that a lifetime of the battery is deteriorated.

Furthermore, in the conventional CCCV charging method, since the charging is stopped until a temperature of the battery drops to the preset temperature or lower when the battery is overheated in order to prevent lifetime deterioration of the battery, there is a problem in that a charging time is prolonged.

### DISCLOSURE

### Technical Problem

The present invention has been proposed in order to resolve the above-described problems, and it is an objective of the present invention to provide an apparatus and a method for cooling and charging an overheated battery, which are capable of operating a constant current charging mode by controlling a pulse width which varies according to a temperature of a battery when the temperature of the battery configured with multiple cells connected in series rises to a preset temperature or higher, and charging the battery by gradually reducing a current when a charging voltage is greater than a preset voltage.

### Technical Solution

To achieve the above-described objective, an apparatus for cooling and charging an overheated battery according to the present invention, the apparatus includes a temperature measurement portion configured to measure a battery temperature; a voltage measurement portion configured to measure a battery voltage; a charging mode setting portion configured to set a charging mode to one mode among a constant current charging mode, a constant voltage charging mode, and a cooling charging mode on the basis of the battery temperature measured at the temperature measurement portion and the battery voltage measured at the voltage measurement portion; and a battery charging portion configured to charge a battery on the basis of a charging signal including a non-charging section and a charging section, and the charging mode set by the charging mode setting portion, wherein the charging mode setting portion sets the charging mode to a cooling charging mode when the battery temperature is greater than or equal to a preset temperature.

The battery charging portion may charge the battery with a constant current in a charging section of the charging signal when the charging mode setting portion sets the charging mode to the cooling charging mode and vary a pulse width of the charging section on the basis of whether the battery temperature measured at the temperature measurement portion rises or drops.

The battery charging portion may reduce the pulse width of the charging section of the charging signal when the battery temperature rises and increase the pulse width of the charging section of the charging signal when the battery temperature drops.

The battery charging portion may gradually decrease a constant current for charging the battery when the battery voltage measured by the voltage measurement portion is greater than or equal to a preset voltage.

The battery charging portion may set a different decrease amount of the constant current according to a magnitude of the constant current.

To achieve the above-described objective, a method for cooling and charging an overheated battery according to an embodiment of the present invention, the method includes measuring a battery temperature; measuring a battery voltage; setting a charging mode to one mode among a constant current charging mode, a constant voltage charging mode, and a cooling charging mode on the basis of the measured battery temperature and the measured battery voltage; and charging a battery on the basis of a charging signal including a non-charging section and a charging section and the set charging mode, wherein the setting of the charging mode includes setting the charging mode to the cooling charging mode when the battery temperature is greater than or equal to a preset temperature.

The charging of the battery may include charging the battery with a constant current in the charging section of the charging signal when the cooling charging mode is set; and varying a pulse width of the charging section on the basis of whether the measured battery temperature rises or drops.

The varying of the pulse width of the charging section may include reducing the pulse width of the charging section when the battery temperature rises; and increasing the pulse width of the charging section of the charging signal when the battery temperature drops.

The charging of the battery may further include gradually decreasing the constant current for charging the battery when the battery voltage measured while the battery is charged in the cooling charging mode is greater than or equal to the preset voltage.

The gradual decreasing of the constant current may include setting a different decrease amount of the constant current according to a magnitude of the constant current for charging the battery.

### Advantageous Effects

In accordance with the present invention, an apparatus and a method for cooling and charging an overheated battery operate a constant current charging mode by controlling a pulse width which varies according to a temperature of a battery when the temperature of the battery configured with multiple cells connected in series rises to a preset temperature or higher, and charge the battery by gradually reducing a current when a charging voltage is greater than a preset voltage, such that there are effects in that a charging time can be minimized by increasing an output transfer speed, a high speed charging is capable of charging about 70% of battery capacity within about 30 minutes, and a cycle characteristic of a battery lifetime can also be improved.

Further, the apparatus and the method for cooling and charging an overheated battery charge the battery by gradually reducing the current when the charging voltage is greater than the preset voltage, such that there is an effect in that a cycle of the battery lifetime can be improved by about 25% compared to the conventional CCCV charging method.

Furthermore, the apparatus and the method for cooling and charging an overheated battery charge the battery by varying a pulse width of a charging section according to a temperature of the battery when the overheated battery is charged, such that there are effects in that a rise in temperature of the battery due to charging can be minimized and the battery can be stably charged.

### DESCRIPTION OF DRAWINGS

FIG. 1 is a diagram for describing a conventional battery charging apparatus.

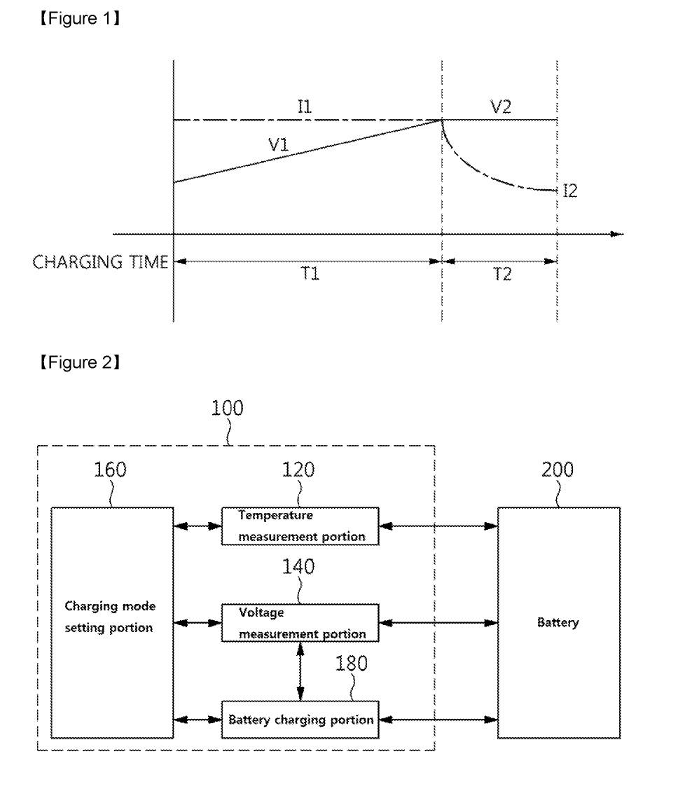

FIG. 2 is a diagram for describing an apparatus for cooling and charging an overheated battery according to an embodiment of the present invention.

FIGS. 3 to 7 are diagrams for describing a battery charging portion of FIG. 2.

FIG. 8 is a flowchart for describing a method for cooling and charging an overheated battery according to an embodiment of the present invention.

FIG. 9 is a flowchart for describing charging of a battery in a constant current charging mode or a constant voltage charging mode of FIG. 8.

FIG. 10 is a flowchart for describing charging of the battery in a cooling mode of FIG. 9.

### MODES OF THE INVENTION

Hereinafter, most preferred embodiments of the present invention will be described in detail with reference to the accompanying drawings in order to facilitate a person skilled in the art to easily implement the technical spirit of the present invention. In giving reference numerals to components of the drawings, the same reference numerals are given to the same components even when the same components are shown in different drawings. Also, in the following description of the present disclosure, if a detailed description of related known configurations or functions is determined to obscure the gist of the present invention, the detailed description thereof will be omitted.

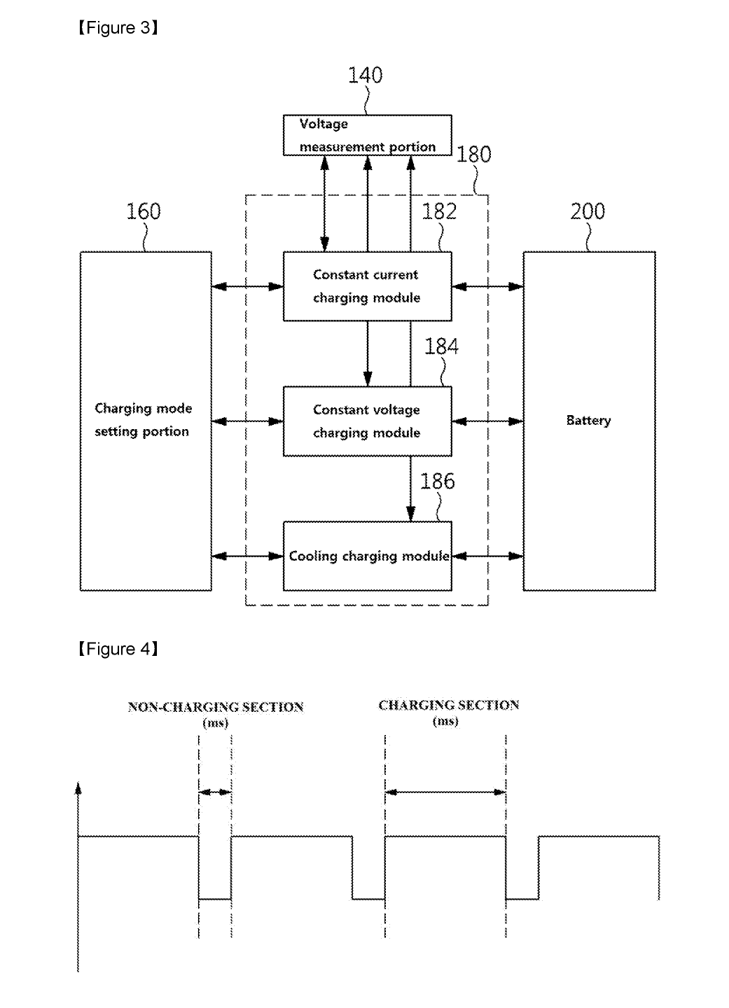

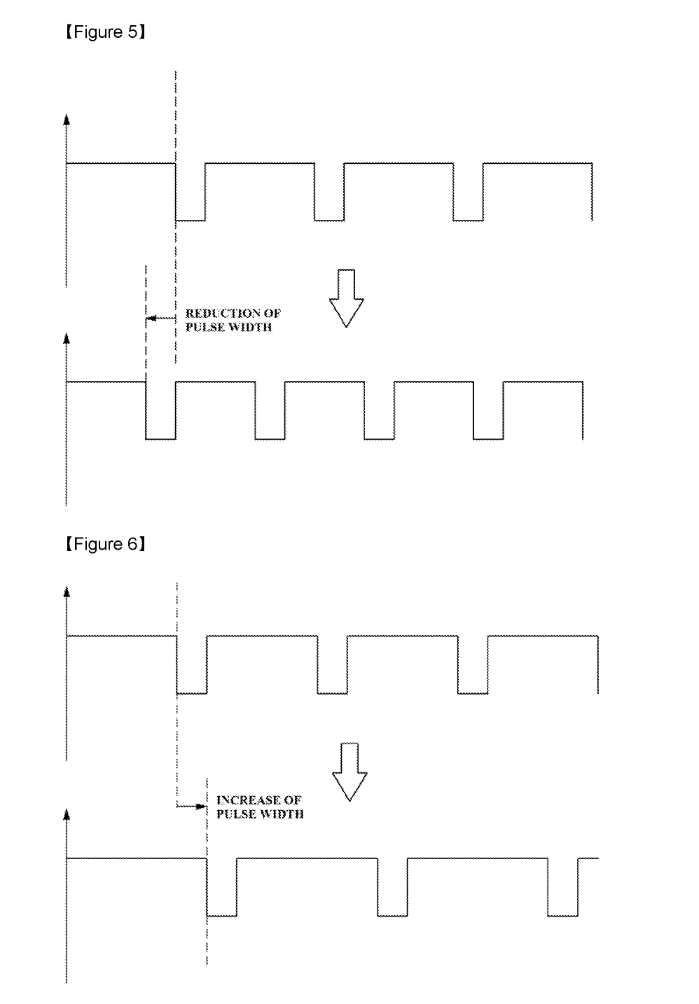

Hereinafter, an apparatus for cooling and charging an overheated battery according to an embodiment of the present invention will be described in detail with reference to the accompanying drawings. FIG. 2 is a diagram for describing an apparatus for cooling and charging an overheated battery according to an embodiment of the present invention. FIGS. 3 to 6 are diagrams for describing a battery charging portion of FIG. 2.

As shown in FIG. 2, an apparatus 100 for cooling and charging an overheated battery (hereinafter referred to as a cooling charging apparatus 100) is configured to include a temperature measurement portion 120, a voltage measurement portion 140, a charging mode setting portion 160, and a battery charging portion 180.

The temperature measurement portion 120 measures a temperature of a battery 200 (hereinafter referred to as a battery temperature) which is charged by the cooling charging apparatus 100. At this point, when charging of the battery 200 begins, the temperature measurement portion 120 measures the battery temperature at a preset time interval. The temperature measurement portion 120 transmits the measured battery temperature to the charging mode setting portion 160.

The voltage measurement portion 140 measures a voltage of the battery 200 (hereinafter referred to as a battery voltage) which is charged by the cooling charging apparatus 100. That is, the voltage measurement portion 140 measures the voltage of the battery 200 when receiving a battery voltage measurement request from the battery charging portion 180. At this point, the voltage measurement portion 140 measures the battery voltage in a state in which the charging of the battery 200 is stopped. The voltage measurement portion 140 transmits the measured battery voltage to the battery charging portion 180.

The charging mode setting portion 160 sets a constant current charging mode when the battery 200 is connected to the cooling charging apparatus 100. The charging mode setting portion 160 sets a constant voltage charging mode when the battery voltage measured at the voltage measurement portion 140 is greater than or equal to a reference voltage. That is, the charging mode setting portion 160 sets the constant current charging mode at an initial charging of the battery 200, and sets the constant voltage charging mode when the battery voltage is greater than or equal to the reference voltage while charging a constant current.

The charging mode setting portion 160 sets a cooling charging mode on the basis of the battery temperature received from the temperature measurement portion 120 and a preset temperature. That is, the charging mode setting portion 160 receives the battery temperature from the temperature measurement portion 120 while charging the battery 200 in the constant current charging mode or the constant voltage charging mode. The charging mode setting portion 160 sets the cooling charging mode on the basis of the received battery temperature and the preset temperature. At this point, the charging mode setting portion 160 sets the cooling charging mode when the battery temperature is greater than or equal to the preset temperature.

The battery charging portion 180 charges the battery 200 on the basis of a charging mode which is set in the charging mode setting portion 160. That is, the battery charging portion 180 charges the battery 200 in one charging mode among the constant current charging mode, the constant voltage charging mode, and the cooling charging mode. To this end, as shown in FIG. 3, the battery charging portion 180 is configured to include a constant current charging module 182, a constant voltage charging module 184, and a cooling charging module 186.

When the charging mode setting portion 160 sets the constant current charging mode, the constant current charging module 182 charges the battery 200 with a constant current on the basis of a charging signal. That is, as shown in FIG. 4, the charging signal includes a non-charging section in which no current is applied, and a charging section in which a constant current is applied to charge the battery 200. The constant current charging module 182 charges the battery 200 by supplying a constant current in the charging section and stops the charging of the battery 200 with the constant current by blocking a supply of the constant current in the non-charging section. The constant current charging module 182 transmits a battery voltage measurement request to the voltage measurement portion 140 in the non-charging section.

When the charging mode setting portion 160 sets the constant voltage charging mode, the constant voltage charging module 184 charges the battery 200 with a constant voltage on the basis of a charging signal. That is, the charging signal includes a non-charging section in which no voltage is applied, and a charging section in which the constant voltage is applied to charge the battery 200. The charging signal includes the charging section and the non-charging section. The constant voltage charging module 184 charges the battery 200 by supplying the constant voltage in the charging section and stops the charging of the battery 200 with the constant voltage by blocking a supply of the constant voltage in the non-charging section. The constant voltage charging module 184 transmits a battery voltage measurement request to the voltage measurement portion 140 in the non-charging section.

When the charging mode setting portion 160 sets the cooling charging mode, the cooling charging module 186 charges the battery 200 with a constant current on the basis of a charging signal. That is, the charging signal includes a non-charging section in which no current is applied, and a charging section in which a constant current is applied to charge the battery 200. The cooling charging module 186 charges the battery 200 by supplying the constant current in the charging section and stops the charging of the battery 200 with the constant current by blocking a supply of the constant current in the non-charging section. The cooling charging module 186 transmits a battery voltage measurement request to the voltage measurement portion 140 in the non-charging section.

When the charging mode setting portion 160 sets the cooling charging mode, the cooling charging module 186 transmits a battery temperature measurement request to the temperature measurement portion 120 at a preset interval. The cooling charging module 186 varies a pulse width of the charging section of the charging signal on the basis of a battery temperature received from the temperature measurement portion 120 and a previously received battery temperature. At this point, when the battery temperature rises, the cooling charging module 186 reduces the pulse width of the charging section of the charging signal. When the battery temperature drops, the cooling charging module 186 increases the pulse width of the charging section of the charging signal. Thereafter, the cooling charging module 186 charges the battery 200 with the constant current on the basis of the charging signal of which pulse width of the charging section is varied. For example, as shown in FIG. 5, when the battery temperature rises, the cooling charging module 186 reduces the pulse width of the charging section while maintaining a pulse width of the non-charging section. As shown in FIG. 6, when the battery temperature drops, the cooling charging module 186 increases the pulse width of the charging section while maintaining the pulse width of the non-charging section.

The cooling charging module 186 gradually decreases the constant current for charging the battery 200 on the basis of the battery voltage and the preset voltage. That is, the cooling charging module 186 transmits the battery voltage measurement request to the voltage measurement portion 140 in the non-charging section of the charging signal. When the battery voltage is greater than or equal to the preset voltage, the cooling charging module 186 charges the battery 200 by gradually decreasing the constant current. For example, as shown in FIG. 7, when a constant current for charging the battery 200 is 2 A and a preset voltage is set to 4.2 V, the cooling charging module 186 decreases the constant current by about 0.2 A to charge the battery 200 with the constant current of about 1.8 A when the battery voltage is greater than or equal to 4.2 V. At this point, as the constant current is decreased, the battery voltage is slightly decreased from 4.2 V and then is increased to 4.2 V again. When the battery voltage is increased to 4.2 V, the cooling charging module 186 charges the battery 200 with a constant current of about 1.6 A, which has been decreased by about 0.2 A. The cooling charging module 186 decreases the constant current by about 0.2 A when the constant current is in a range of about 2 A to about 1 A, by about 0.1 A when the constant current is in a range of about 0.5 A and over to about less than 1 A, and by about 0.05 A when the constant current is in a range of less than 0.5 A.

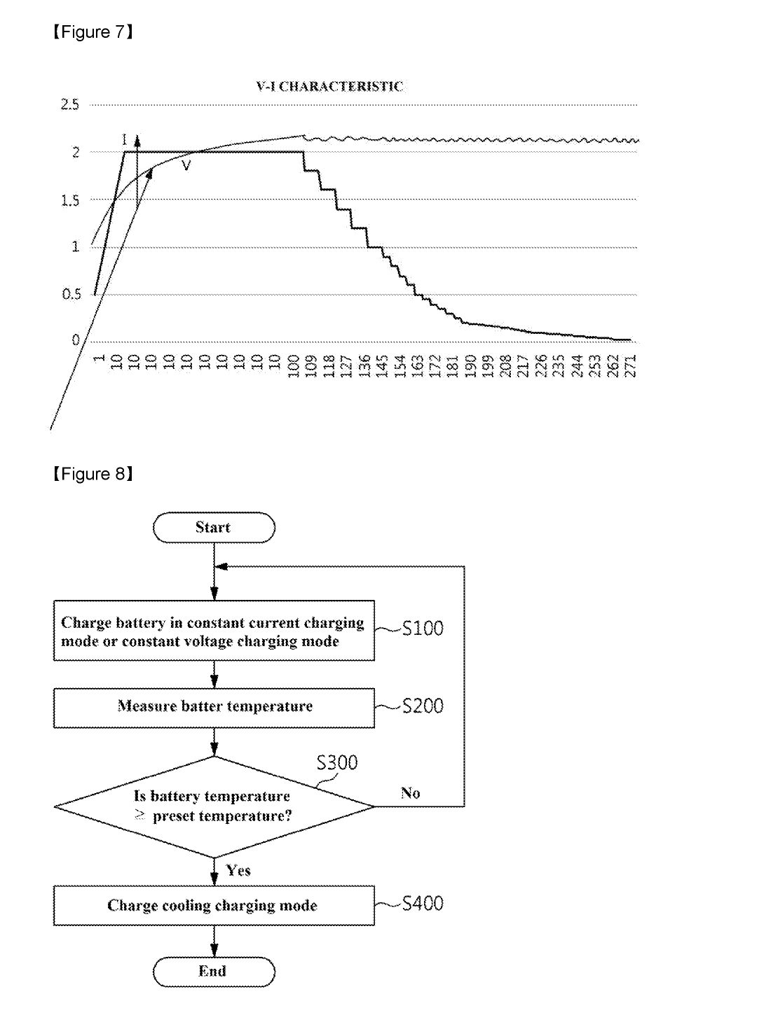

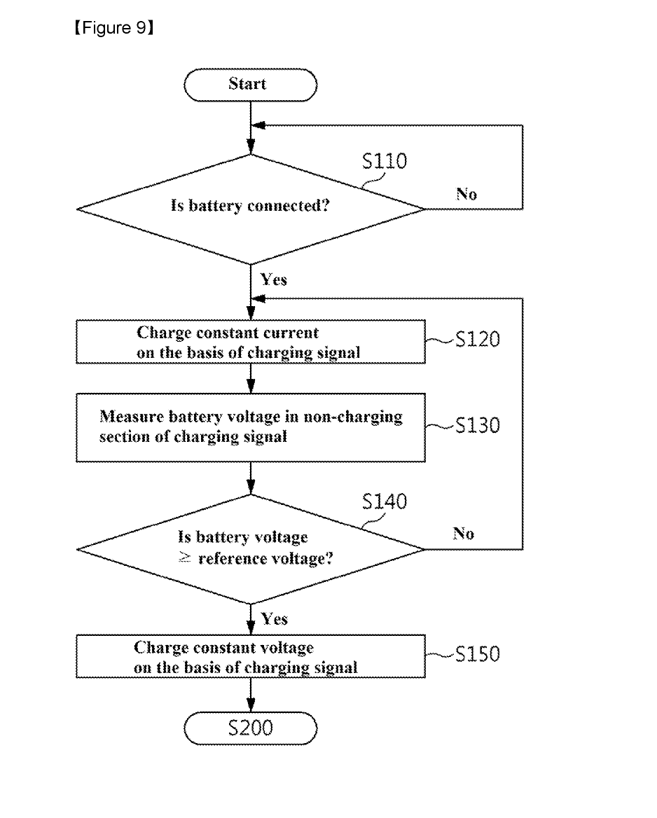

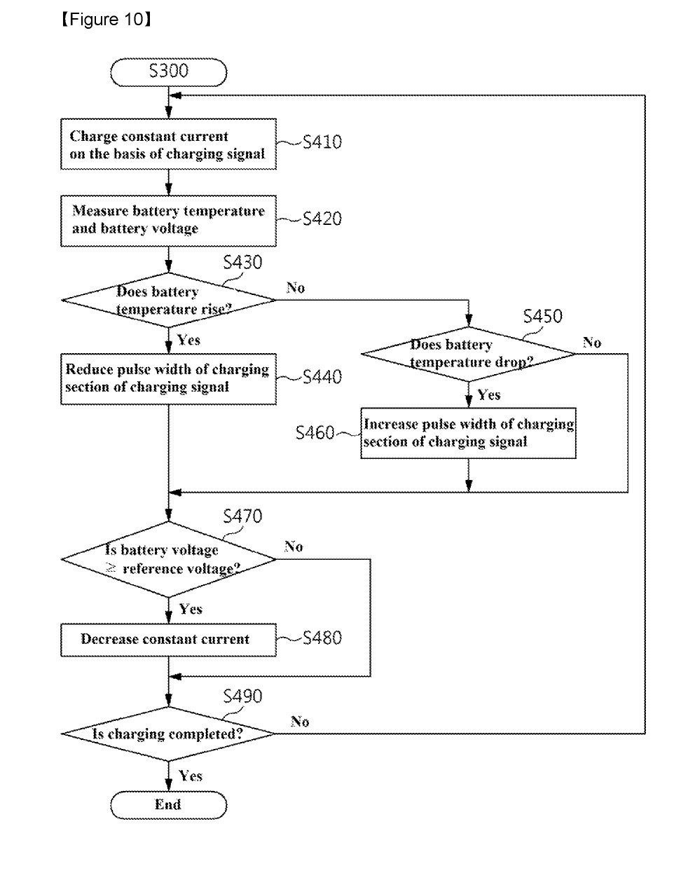

Hereinafter, a method for cooling and charging an overheated battery according to an embodiment of the present invention will be described in detail with reference to the accompanying drawings. FIG. 8 is a flowchart for describing a method for cooling and charging an overheated battery 200 according to an embodiment of the present invention. FIG. 9 is a flowchart for describing charging of the battery 200 in a constant current charging mode or a constant voltage charging mode of FIG. 8, and FIG. 10 is a flowchart for describing charging of the battery in a cooling mode of FIG. 9.

When the battery 200 is connected to the apparatus 100 for cooling and charging an overheated battery (hereinafter referred to as the cooling charging apparatus 100), the cooling charging apparatus 100 charges the battery 200 in a constant current charging mode or a constant voltage charging mode (S100). The charging of the battery 200 in the constant current charging mode or the constant voltage charging mode will be described below with reference to FIG. 9.

When the battery 200 is connected to the cooling charging apparatus 100 (YES in S110), the cooling charging apparatus 100 charges the battery 200 with a constant current on the basis of a charging signal (S120). That is, when the battery 200 is initially connected to the cooling charging apparatus 100, the cooling charging apparatus 100 sets the constant current charging mode. When the constant current charging mode is set, the cooling charging apparatus 100 charges the battery 200 with the constant current on the basis of the charging signal. At this point, the cooling charging apparatus 100 charges the battery 200 by supplying the constant current in a charging section of the charging signal and stops the charging of the battery 200 with the constant current by blocking a supply of the constant current in a non-charging section.

The cooling charging apparatus 100 measures a battery voltage in the non-charging section of the charging signal (S130). That is, the cooling charging apparatus 100 measures the battery voltage when the charging signal is in the non-charging section in a constant current charging state.

When the battery voltage is greater than or equal to a reference voltage (YES in S140), the cooling charging apparatus 100 charges the battery 200 with a constant voltage (S150). That is, the cooling charging apparatus 100 sets the constant voltage charging mode when the battery voltage is greater than or equal to the reference voltage. The cooling charging apparatus 100 charges the battery 200 by supplying a constant voltage in a charging section of the charging signal and stops the charging of the battery 200 with the constant voltage by blocking a supply of the constant voltage in a non-charging section.

The cooling charging apparatus 100 measures a battery temperature while charging the battery 200 in the constant current charging mode or the constant voltage charging mode (S200).

When the measured battery temperature is greater than or equal to a preset temperature (YES in S300), the cooling charging apparatus 100 charges the battery 200 in a cooling charging mode (S400). The charging of the battery 200 in the cooling charging mode will be described below with reference to FIG. 10.

The cooling charging apparatus 100 charges the battery 200 with the constant current on the basis of the charging signal (S410). That is, the cooling charging apparatus 100 charges the battery 200 by supplying the constant current in a charging section and stops the charging of the battery 200 with the constant current by blocking a supply of the constant current in a non-charging section.

The cooling charging apparatus 100 measures a battery temperature and a battery voltage of the battery 200 which is currently charged (S420). At this time, the cooling charging apparatus 100 measures the battery voltage in the non-charging section of the charging signal. The cooling charging apparatus 100 measures the battery temperature at a preset interval.

When the measured battery temperature rises relative to a previously measured battery temperature (YES in S430), the cooling charging apparatus 100 reduces a pulse width of the charging section of the charging signal (S440). That is, when the battery temperature rises above a previously measured temperature, the cooling charging apparatus 100 reduces the pulse width of the charging section so as to cool the battery 200.

When the battery temperature drops below the previous measured temperature (YES in S450), the cooling charging apparatus 100 increases the pulse width of the charging section of the charging signal (S460). That is, when the battery temperature drops below the previous measured temperature, the cooling charging apparatus 100 increases the pulse width of the charging section so as to shorten a charging time of the battery 200.

When the measured battery voltage is greater than or equal to the reference voltage (YES in S470), the cooling charging apparatus 100 decreases the constant current for charging the battery 200 (S480). At this point, the cooling charging apparatus 100 varies a decrease amount of the constant current on the basis thereof and gradually decreases the decrease amount. Here, when the battery voltage is less than or equal to the reference voltage, the cooling charging apparatus 100 maintains the current constant current.

When the charging is not completed (NO in S490), the cooling charging apparatus 100 repeatedly performs the above-described operations S410 to S470.

As described above, the apparatus and the method for cooling and charging an overheated battery operate a constant current charging mode by controlling a pulse width which varies according to a temperature of a battery when the temperature of the battery configured with multiple cells connected in series rises to a predetermined temperature or higher, and charge the battery by gradually reducing a current when a charging voltage is greater than a predetermined voltage, such that there are effects in that a charging time can be minimized by increasing an output transfer speed, a high speed charging is capable of charging about 70% of battery capacity within about 30 minutes, and a cycle characteristic of a battery lifetime can also be improved.

Further, the apparatus and the method for cooling and charging an overheated battery charge the battery by gradually reducing the current when the charging voltage is greater than the predetermined voltage, such that there is an effect in that a cycle of the battery lifetime can be improved by about 25% compared to the conventional CCCV charging method.

Furthermore, the apparatus and the method for cooling and charging an overheated battery charge the battery by varying a pulse width of a charging section according to a temperature of the battery when the overheated battery is charged, such that there are effects in that a rise in temperature of the battery due to charging can be minimized and the battery can be stably charged.

While the present invention has been described with respect to the preferred embodiments of the present invention, the present invention is not limited to the above-disclosed embodiments and it should be understood by those skilled in the art that various changes and modifications may be implemented without departing from the scope of the present invention.

1. An apparatus for cooling and charging an overheated battery, comprising:
a temperature measurement portion configured to measure a battery temperature;
a voltage measurement portion configured to measure a battery voltage;
a charging mode setting portion configured to set a charging mode to one mode among a constant current charging mode, a constant voltage charging mode, and a cooling charging mode on the basis of the battery temperature measured at the temperature measurement portion and the battery voltage measured at the voltage measurement portion; and
a battery charging portion configured to charge a battery on the basis of a charging signal including a non-charging section and a charging section, and the charging mode set by the charging mode setting portion,
wherein the charging mode setting portion sets the charging mode to a cooling charging mode when the battery temperature is greater than or equal to a preset temperature.

2. The apparatus of claim 1, wherein the battery charging portion charges the battery with a constant current in a charging section of the charging signal when the charging mode setting portion sets the charging mode to the cooling charging mode and varies a pulse width of the charging section on the basis of whether the battery temperature measured at the temperature measurement portion rises or drops.

3. The apparatus of claim 2, wherein the battery charging portion reduces the pulse width of the charging section of the charging signal when the battery temperature rises and increases the pulse width of the charging section of the charging signal when the battery temperature drops.

4. The apparatus of claim 2, wherein the battery charging portion gradually decreases a constant current for charging the battery when the battery voltage measured by the voltage measurement portion is greater than or equal to a preset voltage.

5. The apparatus of claim 4, wherein the battery charging portion sets a different decrease amount of the constant current according to a magnitude of the constant current.

6. A method for cooling and charging an overheated battery using an apparatus for cooling and charging an overheated battery, the method comprising:
measuring a battery temperature;
measuring a battery voltage;
setting a charging mode to one mode among a constant current charging mode, a constant voltage charging mode, and a cooling charging mode on the basis of the measured battery temperature and the measured battery voltage; and
charging a battery on the basis of a charging signal including a non-charging section and a charging section and the set charging mode,
wherein the setting of the charging mode includes setting the charging mode to the cooling charging mode when the battery temperature is greater than or equal to a preset temperature.

7. The apparatus of claim 6, wherein the charging of the battery includes:
charging the battery with a constant current in the charging section of the charging signal when the cooling charging mode is set; and
varying a pulse width of the charging section on the basis of whether the measured battery temperature rises or drops.

8. The apparatus of claim 7, wherein the varying of the pulse width of the charging section includes:
reducing the pulse width of the charging section when the battery temperature rises; and
increasing the pulse width of the charging section of the charging signal when the battery temperature drops.

9. The apparatus of claim 7, wherein the charging of the battery further includes gradually decreasing the constant current for charging the battery when the battery voltage measured while the battery is charged in the cooling charging mode is greater than or equal to the preset voltage.

10. The apparatus of claim 9, wherein the gradual decreasing of the constant current includes setting a different decrease amount of the constant current according to a magnitude of the constant current for charging the battery.
